(19) United States
(12) Patent Application Publication
(10) Pub. No.: US 2017/0178009 A1
(43) Pub. Date: Jun. 22, 2017

(54) OPTIMAL SELECTION PROCESSING

(71) Applicant: NCR Corporation, Duluth, GA (US)

(72) Inventors: Matthew Ryan Folds, Snellville, GA (US); Xueling Lu, Lilburn, GA (US); Andrew James Herron, Hoschton, GA (US)

(21) Appl. No.: 14/977,734

(22) Filed: Dec. 22, 2015

(51) Int. Cl. G06N 5/04; G06Q 30/06; G06Q 30/02

(52) U.S. Cl. CPC G06N 5/04; G06Q 30/0207; G06Q 30/0621

(57) ABSTRACT

Items having conditions relevant to various combinations of those items are processed to identity each available combination-condition pair from the various combinations. Each combination-condition pair is evaluated to produce a pair value. An optimal pair value is selected based on a value scale.

### BACKGROUND

There are a variety of technological issues associated with selecting options when each option can be selected in combination with selective other options. Such problems tax computing resources and result in processing delays before a solution can be determined. Many industries encounter such scenarios every day, which can substantial impact the bottom lines of those industries.

As one example, consider the retail industry and a typical consumer transaction in which a plurality of goods are purchased and there exists a plurality of available discounts that can be applied in isolation or in combinations to all or various combinations of the goods. Many times because of the complexity in solving what is the best overall discount for the transaction, the retailer will simply pick one based on some custom-developed selection policies, which may not be the best deal for the consumer, and, in some cases not even the best deal for the retailer.

When this happens, the consumer may later discover that he/she did not get the best deal and may feel cheated by the retailer, which can create customer problems and return loyalty of the consumer. Plus, the customer is likely to express his/her frustration with the retailer to other friends of family members that are also customers of the retailer. So, the retailer may lose the business of more than one customer.

However, resolving the best deal is a complex issue and selecting a solution that takes too much computing resources and/or time in processing can be even more problematic for the retailer. Each transaction can include a variety of stackable and non-stackable discounts. When evaluating the non-stackable discounts, each good or some combination of the goods in the transaction may be applicable to a single non-stackable discount. The problem is factorial in nature, which for even the best computing platforms can be taxing and result in time delays and for a retailer this scenario can be particularly problematic especially during high traffic periods.

### SUMMARY

In various embodiments, methods and a terminal for optimal selecting processing are presented.

According to an embodiment, a method for optimal selection processing is provided. Specifically, in an embodiment, permissible combinations of items in a group are determined based on evaluation of conditions to identify each available combination-condition grouping from the combinations. Next, a combination-condition value is calculated for each available combination-condition grouping. Finally, an optimal combination-condition value is selected from the combination-condition values based on a value scale.

### BRIEF DESCRIPTION OF THE DRAWINGS

FIG. 1A is a diagram of a first example usage scenario for optimal selection processing, according to an example embodiment.

FIG. 1B is a diagram of a second example usage scenario for optimal selection processing, according to an example embodiment.

FIG. 1C is a diagram of a third example usage scenario for optimal selection processing, according to an example embodiment.

FIG. 1D is a diagram listing a process overview of optimal selection processing, according to an example embodiment.

FIG. 1E is a diagram depicting a visual representation of a usage for optimal selection processing, according to an example embodiment.

FIG. 1F is a diagram depicting processing component interaction for optimal section processing, according to an example embodiment.

FIG. 1G is a diagram depicting a method for optimal selection processing, according to an example embodiment.

FIG. 1H is a diagram depicting another method for optimal selection processing, according to an example embodiment.

FIG. 1I is a diagram of another method for optimal selection processing, according to an example embodiment.

FIG. 1J is a diagram of an example system practicing optimal selection processing, according to an example embodiment.

FIG. 2 is a diagram of a method for optimal selection processing, according to an example embodiment.

FIG. 3 is a diagram of another method for optimal selecting processing, according to an example embodiment.

FIG. 4 is a diagram of an optimal selection terminal, according to an example embodiment.

### DETAILED DESCRIPTION

As used herein “optimal” is intended to mean, the largest allowable discount that can be applied to a given consumer transaction. Moreover, a “basket” refers to the items (goods or services) present in a given consumer transaction. The terms “offer,” “promotion,” and “discount” may be used synonymously and interchangeably herein.

As will be demonstrated herein and below, methods and a terminal for optimal selection processing are presented. The processing improves processor throughput and memory efficiency on the hardware devices, which implement the processing optimal selection processing.

As initial context, when a customer of a retailer purchases items from a retailer and there are multiple non-stackable offers attached to the items, the processing (presented herein and below) selects the offers that generate the deepest (largest available) total discount for the customer's transaction. The processing considers the types of available promotions and produces the optimal overall discount for the transaction in a processor efficient manner with reduced processor throughput time lag.

Retailers can have promotions running regularly, and sometimes there are even special promotions that have to be run for a short period of time on top of their regular promotions (offers). Existing solutions place processing limitations on the types of offers that these solutions can support. The processing presented herein delivers a complete solution, which have no such offer type limitations and is generic in nature, which provides easier integration into existing retail systems as an integrated enhancement to those existing retail systems.

As will be demonstrated, instead of focusing on how to select items for processing of each overlapping offer, the processing presented herein takes advantage of the underlying hardware's computation power and implements a combinatorial approach when selecting an optimal combination of offers available in a customer's basket of items.

This is achieved by: 1) determining overlapping offers based on a current-basket of items for a customer; 2) sorting out item-level offers and non-item best deal offers; 3) determining all possible combinations (item-level best deal offers are processed through a special method process in the combinations); 4) calculating, for each combination, a total discount value (item-level best deal offers are processed through a special method process for application); and 5) selecting the combination, which yields a largest total discount for the basket and applying that discount to reduce a total price for the customer transaction.

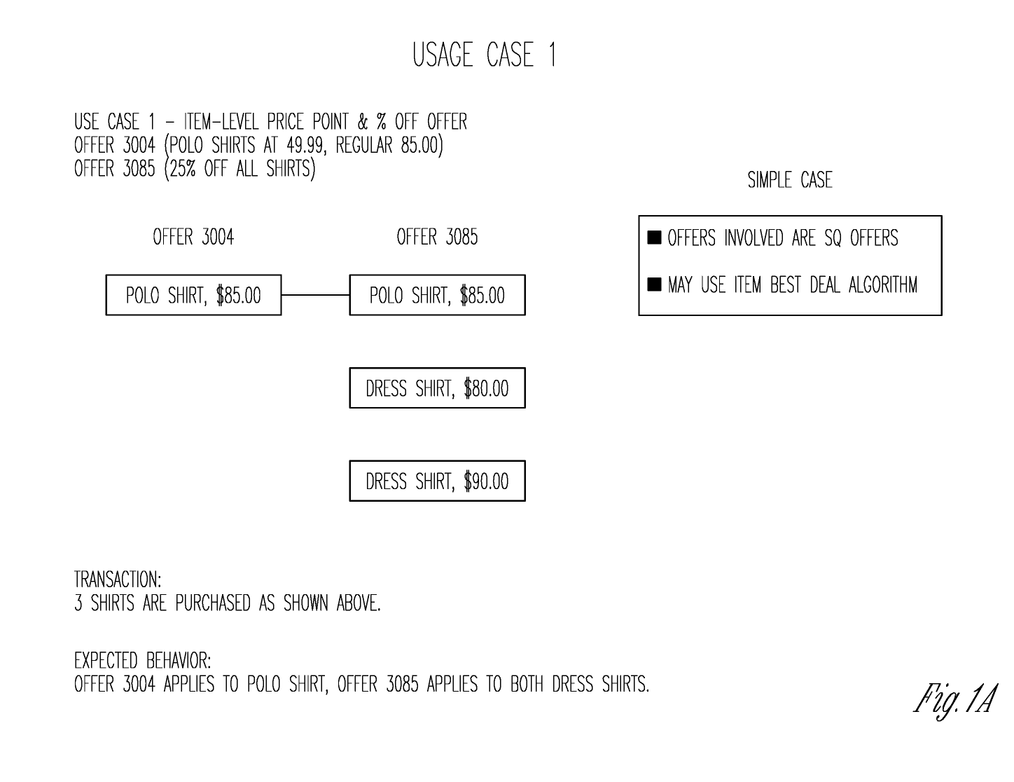

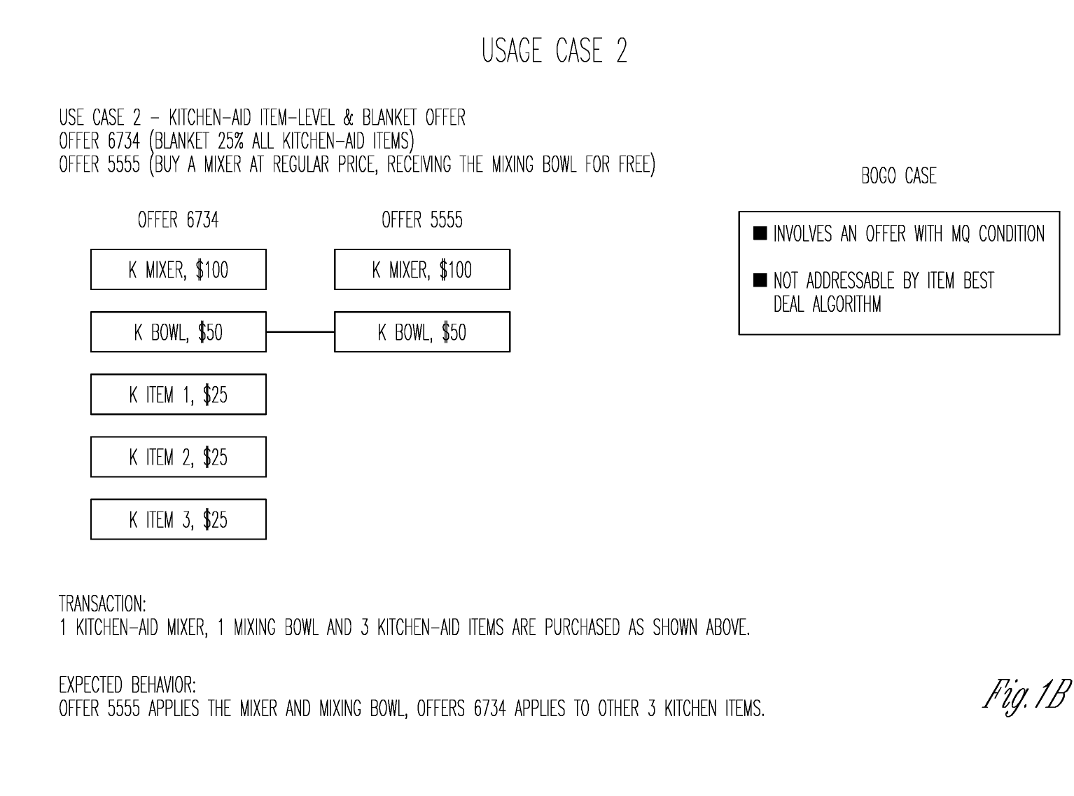

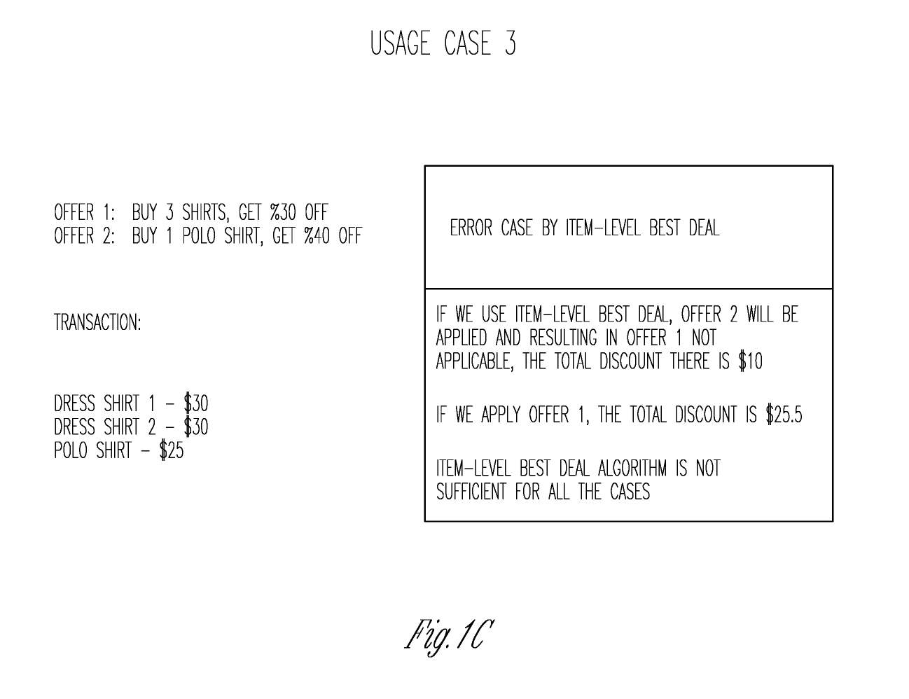

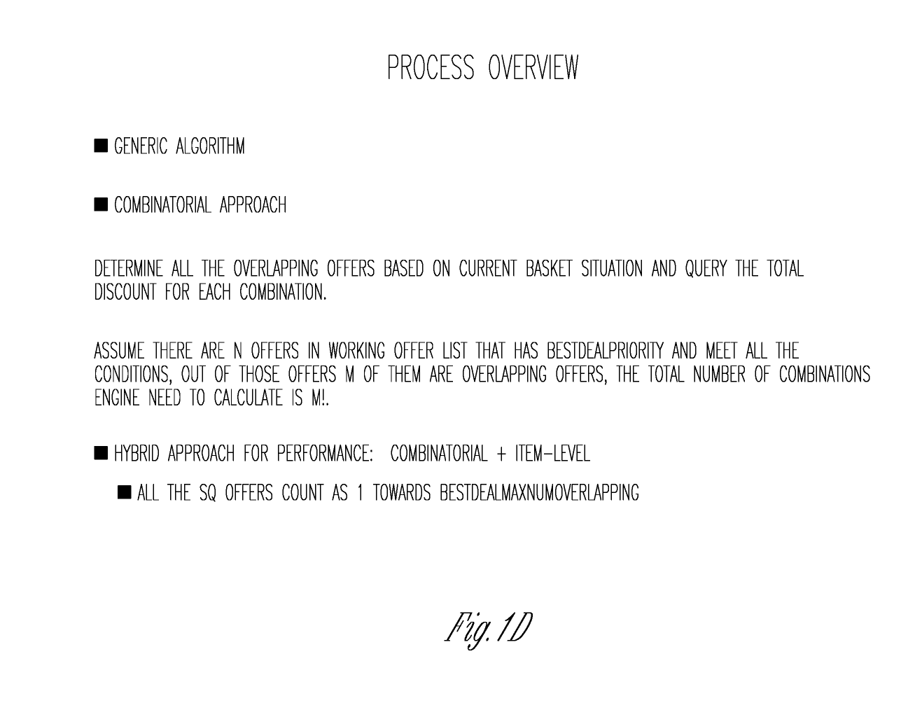

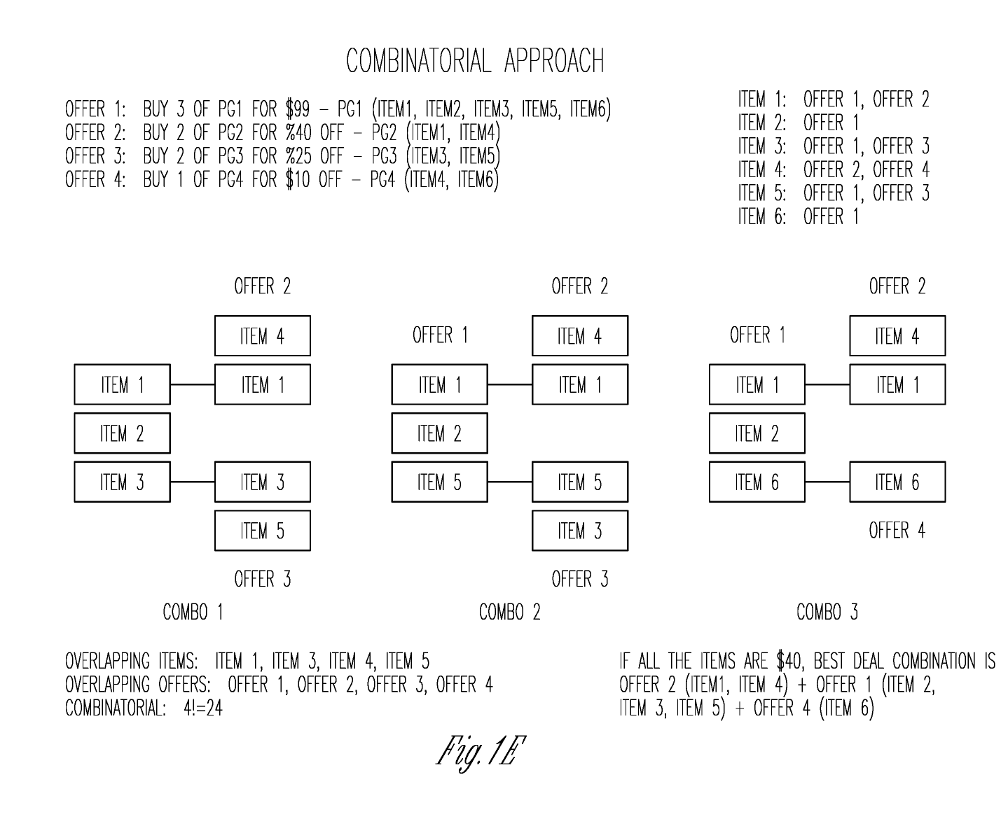

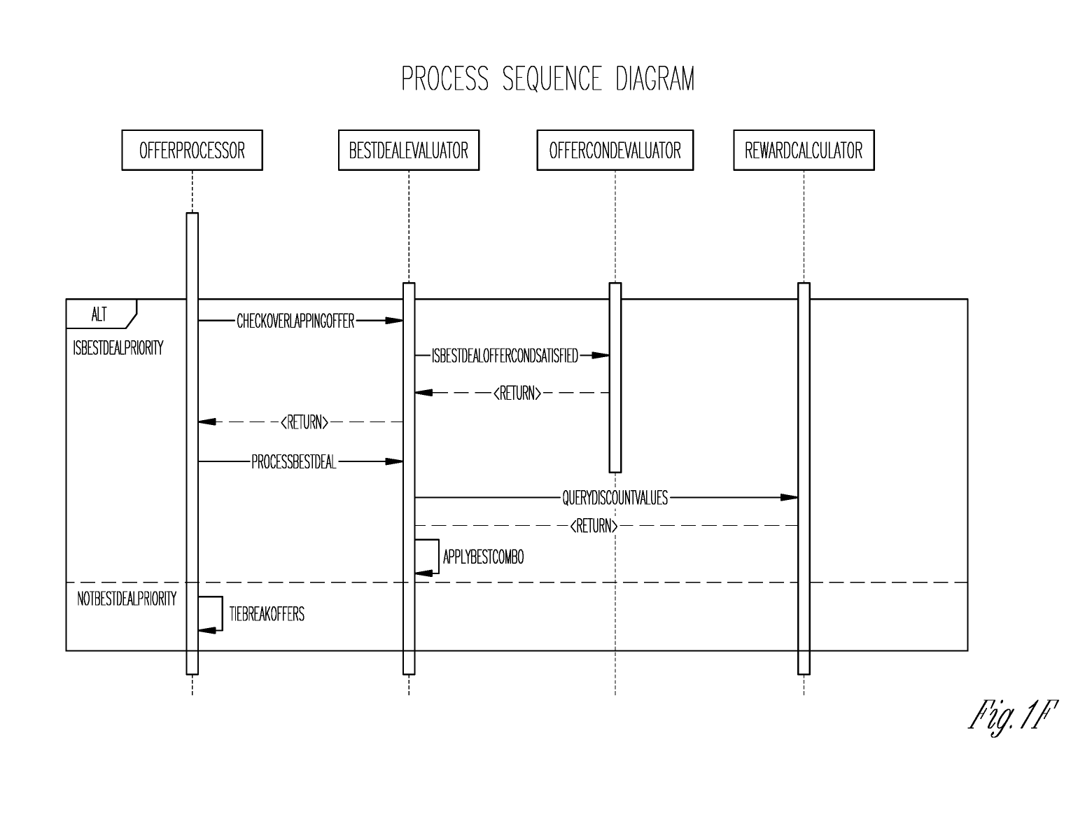

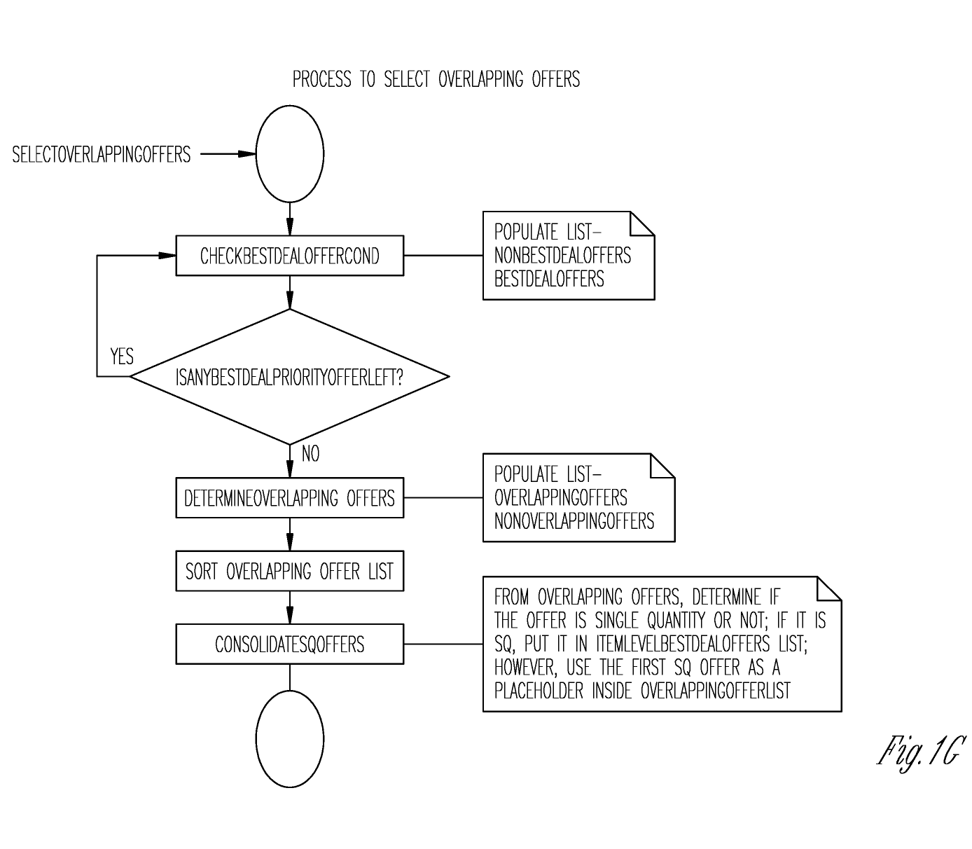

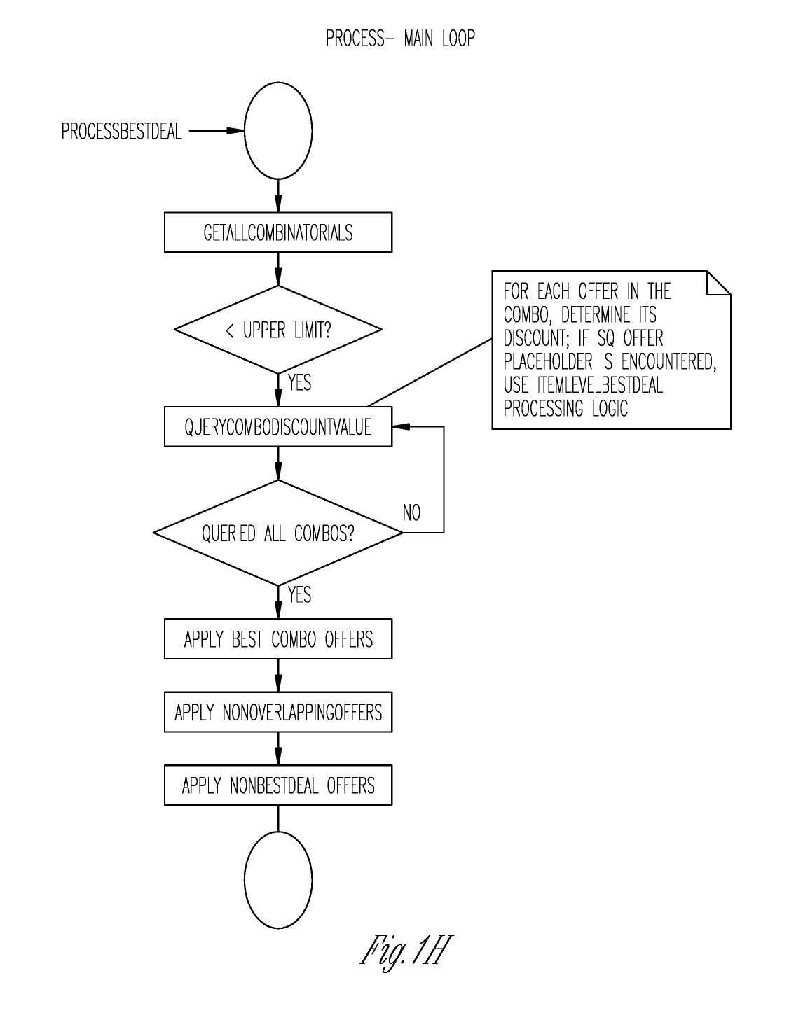

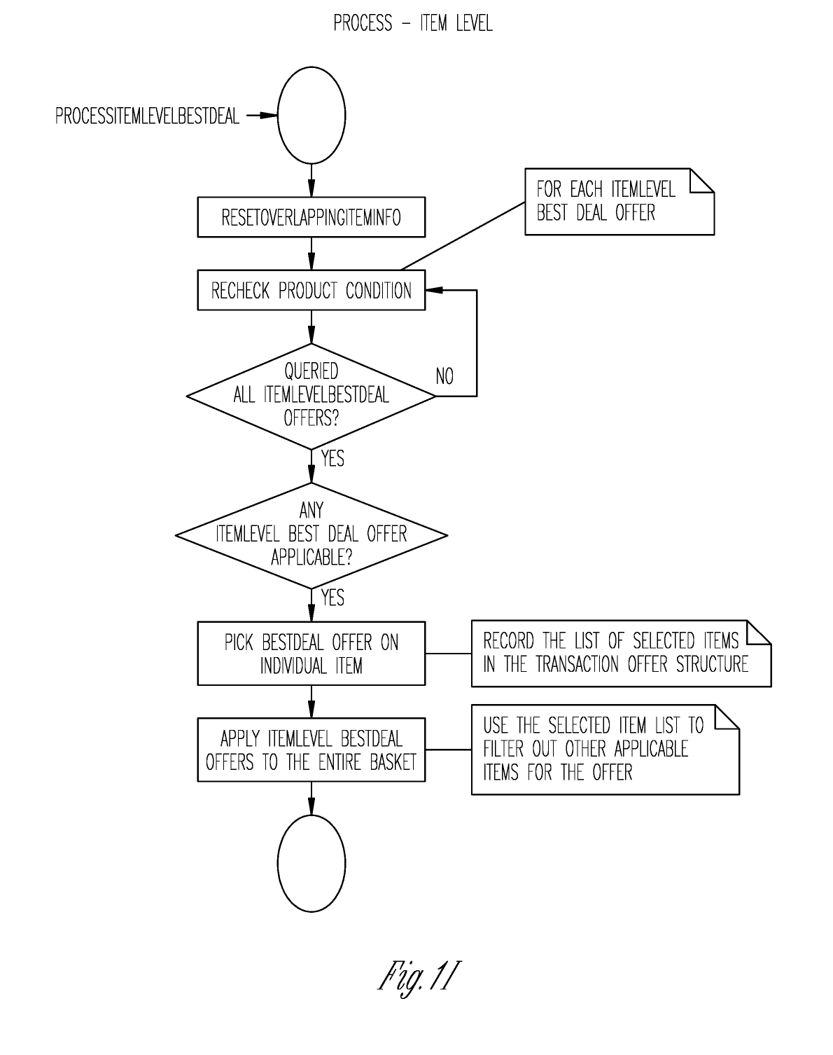

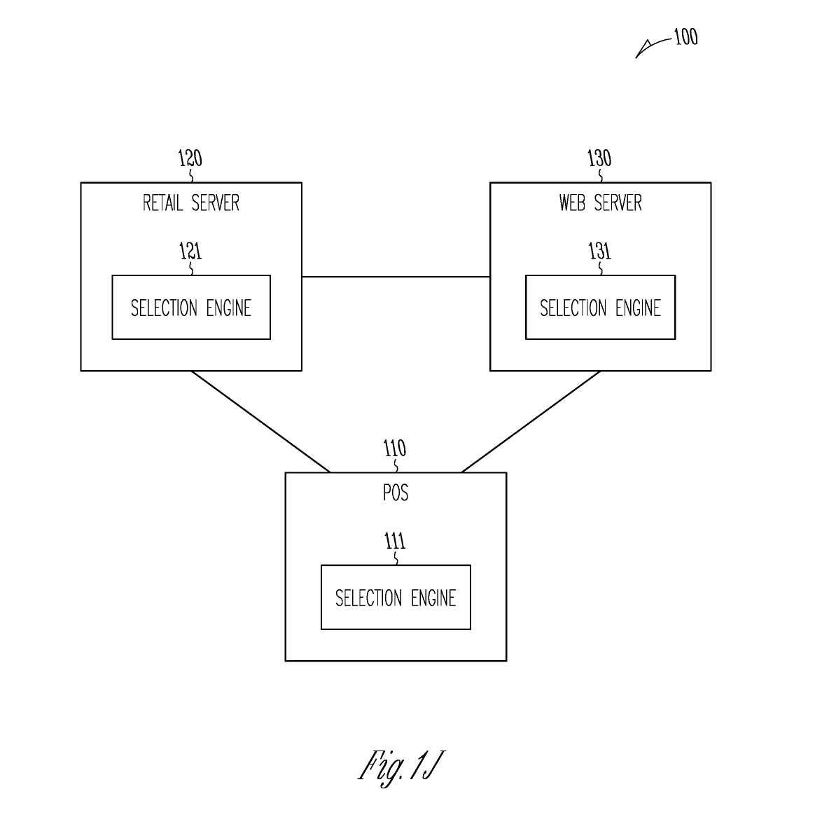

Initially, the processing for optimal selection processing is discussed within the context of three-sample usage scenarios within a retail environment in the FIGS. 1A-1C. It is to be noted that a variety of situations may occur and the presented scenarios are discussed for purposes of comprehension and understanding of example situations for the optimal selection processing. Therefore, the presented usage scenarios are not intended in any way to be all inclusive of the various embodiments for optimal selection processing provided herein.

FIG. 1A is a diagram of a first example usage scenario for optimal selection processing, according to an example embodiment.

The usage scenario presented in the FIG. 1A shows an item-level price point with a percentage off offer (discount offered). Here, the optimal selection processing identifies Single Quantity (SQ) offers in which item best deal processing is used. Offer 3004 states that Polo shirts are available for $49.499 and regularly priced at $85. Offer 3085 states that all shirts are 25% off. The transaction includes the purchase of three shirts: a Polo shirt for $85 and two dress shirts for $80 each for a total initial price before any offer is applied of $245. The offers are non-stackable, the processing applies: 1) offer 3004 to the Polo Shirt resulting in a discount of $35.01 and 2) offer 3085 for the two dress shirts resulting in a discount of $40. The processing then applies a total discount of $75.01 and the price for the transaction is presented as $169.96.

FIG. 1B is a diagram of a second example usage scenario for optimal selection processing, according to an example embodiment.

In the second usage scenario, involves a Multiple Quantity (MQ) condition that is not addressable by best deal processing. Here, offer 6734 states all Kitchen-aid items are 25% off and offer 5555 states if a mixer at regular price is purchased, then a mixing bowl is free. The transaction includes 1 Kitchen-aid mixer for $100, 1 mixing bowl for $50, and three Kitchen-aid other items at $25 apiece for $75 total. The transaction price before any discount is applied is $225.

The processing resolves the optimal selection mix of the offers to apply offer 5555 for a total price of $100 (bowl is free) and offer 6734 to the three other Kitchen-aid items for a total price of $56.25, resulting in final transaction price of $156.25, which is then applied by the processing for the transaction.

FIG. 1C is a diagram of a third example usage scenario for optimal selection processing, according to an example embodiment.

The third usage scenario, illustrates that the optimal selection processing can sometimes elect an approach to arrive at optimal selection that is not a best deal processing.

Offer 1 states if 3 shirts are purchased there is a 30% discount and Offer 2 states if 1 Polo shirt is purchased there is a 40% discount. The transaction includes 2 dress shirts at $30 apiece (for a total of $60) and a Polo shirt for $25 for a total initial transaction price of $85 before any discounts are applied. If Offer 2 is selected by the processing, then the total is $10 the transaction price for a total final price of $75 and Offer 1 is unavailable. But, if Offer 2 is applied the total discount is $25.50 for a total final price of $34.50. Offer 2 is applied by the processing to the final transaction price.

FIG. 1D is a diagram listing a process overview of optimal selection processing, according to an example embodiment.

The FIG. 1D illustrates the processing overview associated with the optimal selection processing for a best deal approach. It is generic (thus, easily integrated into existing retail promotion-based systems) and uses a combinatorial approach.

First all overlapping offers are determined by the processing based on a current basket situation and a total available discount for each combination is resolved. Assuming N (integer greater than 0) is present in the available offer list having a best deal priority flag set with all needed offer conditions met and having M overlapping offers, then, the total number of combinations that the processing (referred to as engine in FIG. 1D) calculates is M!. This is a hybrid approach for computing performance: combinatorial plus item-level and all SQ offers count as 1 for the best deal maximum number of overlapping offers.

FIG. 1E is a diagram depicting a visual representation of a usage for optimal selection processing, according to an example embodiment.

The FIG. 1E illustrates a usage scenario for the combinatorial approach discussed in the FIG. 1D.

The offers are broken into the combinations available, resulting in 4! combinations. The processing resolves the best deal combination as Offer 2 for items 1 and 4 plus offer 1 for items 2 and 3 plus offer 4 for item 6 (assuming all items being purchased for $40).

FIG. 1F is a diagram depicting processing component interaction for optimal section processing, according to an example embodiment.

The FIG. 1F illustrates a best deal processing sequence diagram with four sub-processing components for processing the offer (OfferProcessor), the best deal (BestDealEvaluator), the offer conditions (OfferCondEvaluator), and loyalty rewards (RewardCalculator).

FIG. 1G is a diagram depicting a method for optimal selection processing, according to an example embodiment.

The FIG. 1G illustrates the processing for selecting overlapping offers. Initially, the best deal offer conditions are checked, this processing step iterates until there are no best deal priority offers left for condition processing. When the best deal offer conditions are completed, processing passes to a processing step that determines the overlapping offers. Then, the overlapping offers are sorted and SQ offers are consolidated.

FIG. 1H is a diagram depicting another method for optimal selection processing, according to an example embodiment.

The processing reflected in the FIG. 1H illustrates the best deal processing main loop. First, all combinations are resolved when the upper limit is reached processing passed to determine the total discount for each combination. Once all combinations have their discounts resolved for the basket, the best (largest discount value) combination offers are applied. Then, any non-overlapping offers are applied. Finally, any non-best deal offers are applied.

FIG. 1I is a diagram of another method for optimal selection processing, according to an example embodiment.

The FIG. 1I illustrates processing for item-level best deal processing. Overlapping item information is reset and item (product) condition processing occurs. Once that processing completes a check is made to see if any item level best deal offer is applicable and the best (highest discount value) deal offer is selected on the item being processed. Finally, the processing applies item level best deal offers to the entire basket.

The above-presented embodiments and other embodiments of the optimal selection processing is now discussed with reference to the FIGS. 1J and 2-4.

FIG. 1J is a diagram of an example system 100 practicing optimal selection processing, according to an example embodiment. The various components are illustrated and the arrangement of the components is presented for purposes of illustration only. It is to be noted that other arrangements with more or less components are possible without departing from the optimal selection teachings presented herein and below.

The techniques and methods presented herein above and below for optimal selection processing can be implemented in whole or in part in one, all, or some combination of the components shown with the system 100. The techniques and methods (presented above and below) are programmed as executable instructions in memory and/or non-transitory computer-readable storage media and processed on one or more processors associated with the components.

The system includes a Point-Of-Sale (POS) terminal 110, a retail server 120, and a web server 130.

The processing described above with reference to the FIGS. 1A-Ii is included in the selection engines 111 (of the POS 110), 121 (of the retail server 120), and 131 (of the web server 130).

In an embodiment, the system 100 includes just one instance of the selection engines (111, 121, or 131).

In an embodiment, the system 100 includes some combination of the selection engines (111, 121, and/or 131).

In an embodiment, the system 100 includes all of the selection engines (111, 121, and 131).

In an embodiment, the selection engines (111, 121, and/or 131) are integrated into a retail promotion engine (software product or system) as an enhancement thereto.

In an operational scenario, a consumer obtains a grouping of items for purchase from a retailer. This can occur in person at the POS 110 or over the Internet through a client-operated device and a web-based interface over a network connection through the web server 130.

In a situation where the consumer is purchasing in person at the POS 110, the optimal selection processing (described in the FIGS. 1A-1i) can be processed by the POS selection engine 111 or offloaded to the retail server selection engine 121 over a network connection between the POS 110 and the retail server 120.

In a situation where the consumer is purchasing over an Internet connection through a consumer-operated computing device, the optimal selection processing is processed by the selection engine 131 of the web server 130.

Again, as used herein and throughout the term “engine” refers to one or more software modules implemented as executable instructions, which reside in a non-transitory computer-readable storage media or memory and which are executed from that media or memory by one or more processors of a hardware computing-device.

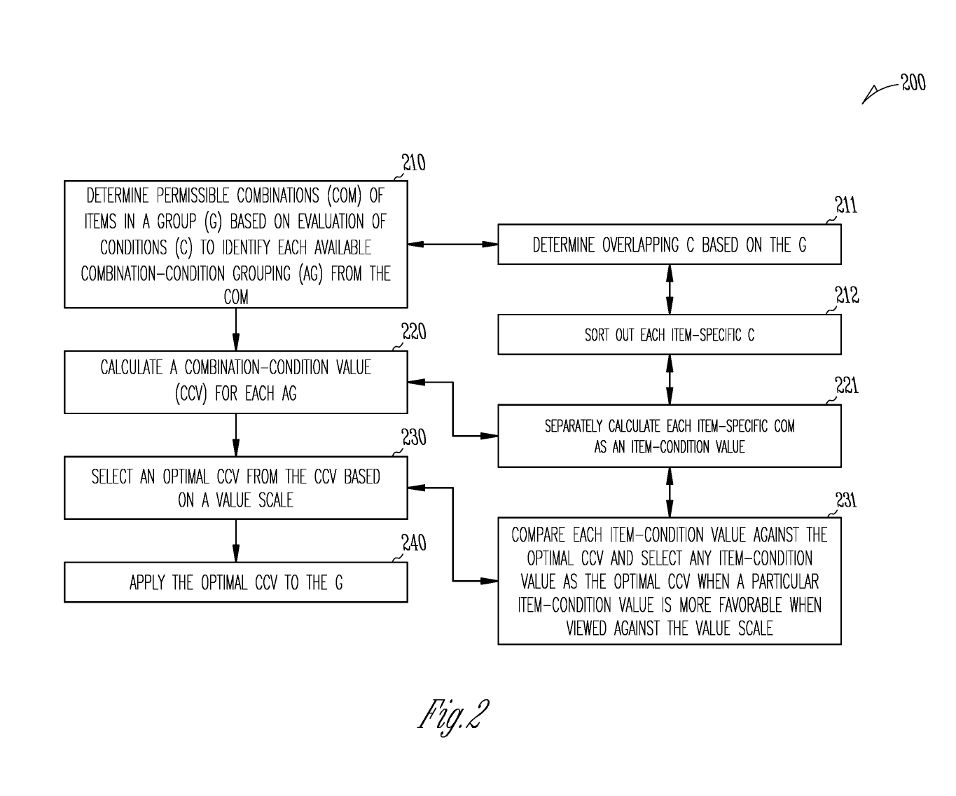

FIG. 2 is a diagram of a method 200 for optimal selection processing, according to an example embodiment. The software module(s) that implement the method 200 is referred to as a “selection manager.” Moreover, the executable instructions for the selection manager are programmed and residing within memory and/or a non-transitory computer-readable (processor-readable) storage medium and executed by one or more processors of a device. The processors are specifically configured and programmed to process the selection manager. The selection manager has access to one or more networks. The networks are wired, wireless, or a combination of wired and wireless.

In an embodiment, the device that executes the selection manager is a self-service checkout device, a cashier-assisted checkout device, a kiosk, a server, a POS terminal, a cloud environment having multiple devices, and/or a mobile device such as: a smart phone, a tablet, a laptop, or a wearable processing device (glasses, watch, etc.). In an embodiment, the device can be multiple hardware devices that act logically as one device.

In an embodiment, the device that executes the selection manager is the POS 110 of the FIG. 1J.

In an embodiment, the device that executes the selection manager is the retail server 120 of the FIG. 1J.

In an embodiment, the device that executes the selection manager is the web server 130 of the FIG. 1J.

In an embodiment, the selection manager is the processing described above with respect to the FIGS. 1A-1J (which includes the selection engines (111, 121, and/or 131 of the FIG. 1J).

At 210, the selection manager determines permissible combinations of items in a group based on evaluation of conditions to identify each available combination-condition grouping from the combinations. Permissible combinations can include those combinations where conditions permit overlapping with other combinations of the items and where conditions do not permit overlapping with other combinations of the items. Moreover, in some instance, a combination can include a single item (such as with single quantity conditions as described above in the FIGS. 1A-1J.

According to an embodiment, at 211, the selection manager determines overlapping conditions based on the grouping. That is the overlapping conditions permit item combinations that include one or more of the same items or types of items (product groupings in the retail scenario).

In an embodiment of 211 and at 212, the selection manager sorts out each item-specific condition. These are single quantity item conditions meaning they apply to just a single item in the grouping.

At 220, the selection manager calculates a combination-condition value for each available combination-condition grouping.

In an embodiment of 212 and 220, at 221, the selection manager separately calculates each item-specific combination as an item-condition value.

At 230, the selection manager selects an optimal combination-condition value from the combination-condition values based on a predefined value scale. In an embodiment, the value scale is a dollar amount, such that the optimal combination-condition value is a largest discount value (dollar amount).

In an embodiment of 221 and 230, at 231, the selection manager compares each item-specific value and selects any item-condition value as the optimal combination-condition value when a particular item-condition value is more favorable when viewed against the value scale. This is a situation where the best deal may not apply as discussed above with reference to the FIG. 1C.

According to an embodiment, at 240, the selection manager applies the optimal combination-condition value to the group. In an embodiment, the items are goods and the group is associated with a transaction, the optimal-condition value is a largest available discount value for the transaction of times, and the final transaction price is the price of the transaction discounted by the largest discount value (as described above with reference to the FIGS. 1A-1J).

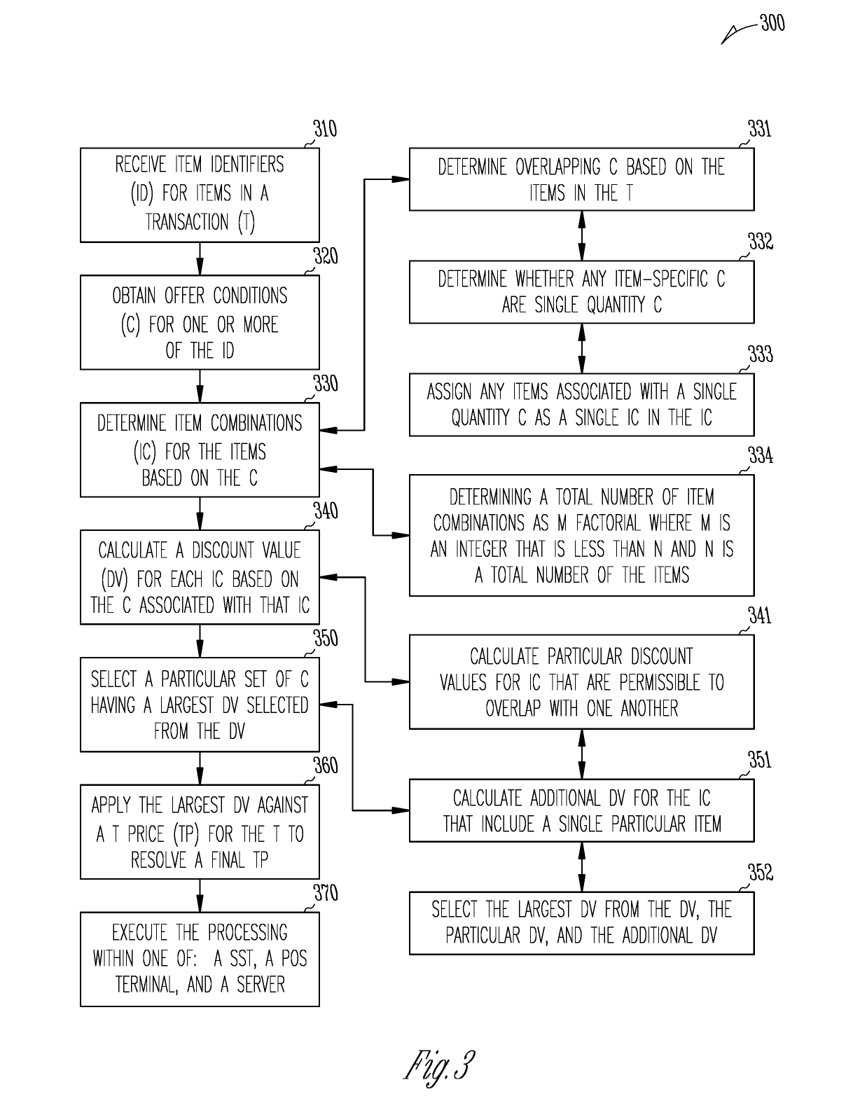

FIG. 3 is a diagram of another method 300 for optimal selecting processing, according to an example embodiment. The software module(s) that implement the method 300 is referred to as a “promotion engine.” The executable instructions of the promotion engine are implemented as instruction and programmed within memory and/or a non-transitory computer-readable (processor-readable) storage medium that executes on one or more processors of a device; the processors of the device are specifically configured to execute the promotion engine. The promotion engine has access to one or more networks; the networks are wired, wireless, or a combination of wired and wireless.

In an embodiment, the device that executes the promotion engine is a Self-Service Terminal (SST) including: a self-service checkout terminal, a kiosk, or Automated Teller Machine.

In an embodiment, the device that executes the promotion engine is a mobile device including: a tablet, a laptop, a smart phone, or a wearable processing device.

In an embodiment, the device that executes the promotion engine is a server.

In an embodiment, the device that executes the promotion engine is a cloud computing environment including one or more hardware device cooperating as one logical device.

In an embodiment, the device that executes the promotion engine is the POS terminal 110 of the FIG. 1J.

In an embodiment, the device that executes the promotion engine is the retail server 120 of the FIG. 1J.

In an embodiment, the device that executes the promotion engine is the web server 130 of the FIG. 1J.

In an embodiment, the promotion engine is the processing described above with the FIGS. 1A-1J (including the selection engines 111, 121, and/or 131 of the FIG. 1J).

In an embodiment, the promotion engine is the method 200 of the FIG. 2.

At 310, the promotion engine receives item identifiers for items in a transaction during a retail transaction of a consumer with a retailer.

At 320, the promotion engine obtains offer conditions associated with the item identifiers, such as by accessing, over a network connection, an offer repository for items of the retailer.

At 330, the promotion engine determines item combinations for the items based on the item identifiers.

In an embodiment, at 331, the promotion engine determines permissible and impermissible overlapping offer conditions associated with the items and item combinations.

In an embodiment of 331 and at 332, the promotion engine determines whether any item-specific offer conditions are single quantity conditions.

In an embodiment of 332 and at 333, the promotion engine assigns any items associated with a single quantity condition as a single item combination in the item combinations.

In an embodiment, at 334, the promotion engine determines a total number of item combinations as M! (Factorial), where M is an Integer that is less than N, and N is the total number of items in the transaction.

At 340, the promotion engine calculates a discount value for each item combination based on the offer conditions associated with that item combination for which a particular discount value is being calculated.

In an embodiment, at 341, the promotion engine calculates particular discount values for item combinations that are permissible to overlap with one another

At 350, the promotion engine selects a particular set of offer conditions having a largest discount value selected from the discount values calculated at 340.

In an embodiment of 341 and 350, at 351, the promotion engine calculates additional discount values for the item combinations that include a single particular item (single quantity conditions and single quantity item combinations).

In an embodiment of 351 and at 352, the promotion engine selects the largest discount value from the discount values, the particular discount values (341), and the additional discount values (351).

At 360, the promotion engine applies the largest available discount value against the transaction price for the items of the transaction to resolve a final transaction price.

According to an embodiment, at 370, the promotion engine executes on a device that is one of: a SST, a POS terminal, and a server. In an embodiment, the server is the retail server 120 of the FIG. 1J. In an embodiment the server is the web server 130 of the FIG. 1J. In an embodiment, the POS terminal is the POS terminal 110 of the FIG. 1J.

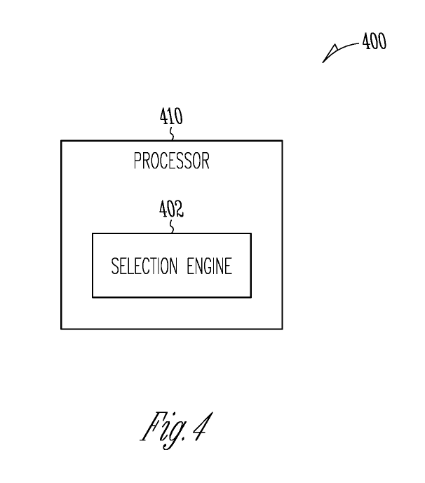

FIG. 4 is a diagram of an optimal selection terminal 400, according to an example embodiment. The components of the optimal selection terminal 400 are programmed and reside within memory and/or a non-transitory computer-readable medium and execute on one or more processors of one or more devices. The optimal selection system terminal is operational over a network and the network can be wired, wireless, or a combination of wired and wireless.

In an embodiment, the optimal selection terminal 400 implements, among other things, any, some combination, and/or all of the processing discussed above with respect to the FIGS. 1A-1J (including selection engines 111, 121, and/or 131 of the FIG. 1J) and the FIGS. 2-3.

In an embodiment, the optimal selection terminal 400 includes any of the hardware devices that were presented as embodiments for executing the processing discussed above with respect to the FIGS. 1A-1J and 2-3.

The optimal selection terminal 400 includes a processor 401 and a selection engine 402.

In an embodiment, the processor 401 is part of any of the hardware devices that were presented as embodiments for executing the processing discussed above with respect to the FIGS. 1A-1J and 2-3.

The selection engine 402 is configured to: 1) execute on the processor 401, resolve a largest discount value for a transaction having multiple items and multiple offer conditions based on single item combinations producing single item discount values for the transaction and multiple item combinations producing multiple item combination discount values.

In an embodiment, the selection engine 402 is further configured to resolve the largest discount value based on permissible overlapping item combinations and impermissible overlapping item combinations.

In an embodiment, the selection engine 402 is integrated into a retail promotion engine as an enhancement to promotion processing for that retail promotion engine.

In an embodiment, the terminal 400 is a server that resolves the largest discount value for a POS terminal that is processing the transaction remove from the server over a network connection. In an embodiment, the server is the retail server 120 of the FIG. 1J. In an embodiment, the server is the web server 130 of the FIG. 1J. In an embodiment the POS terminal is the POS terminal 110 of the FIG. 1J.

In an embodiment, the terminal 400 is one of: a SST, a POS terminal, and ATM, a retail server, a web server, and a mobile device.

In an embodiment, the selection engine 401 is any, some combination, and/or all of the processing discussed above with respect to the FIGS. 1A-1J (including selection engines 111, 121, and/or 131 of the FIG. 1J) and the FIGS. 2-3.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
determining permissible combinations of items in a group based on evaluation of conditions to identify each available combination-condition grouping from the combinations;
calculating a combination-condition value for each available combination-condition grouping; and
selecting an optimal combination-condition value from the combination-condition values based on a value scale.

2. The method of claim 1 further comprising, applying the optimal combination-condition value to the group.

3. The method of claim 1, wherein determining further includes determining overlapping conditions based on the group.

4. The method of claim 3, wherein determining further includes sorting out each item specific condition.

5. The method of claim 4, wherein calculating further includes separately calculating each item-specific combination as an item-condition value.

6. The method of claim 5, wherein selecting further includes comparing each item-specific value and select any item-condition value as the optimal combination-condition value when a particular item-condition value is more favorable when viewed against the value scale.

7. A method, comprising:
receiving, by a promotion engine executing on a hardware device, item identifiers for items in a transaction;
obtaining, by the promotion engine, offer conditions associated with one or more of the item identifiers;
determining, by the promotion engine, item combinations for the items based on the offer conditions;
calculating, by the promotion engine, a discount value for each item combination based on the offer conditions associated with that item combination;
selecting, by the promotion engine, a particular set of offer conditions having a largest discount value selected from the discount values; and
applying, by the promotion engine, the largest discount value against a transaction price for the transaction to resolve a final transaction price.

8. The method of claim 7, wherein determining further includes determining overlapping offer conditions based on the items in the transaction.

9. The method of claim 8, wherein determining further includes determine whether any item-specific offer conditions are single quantity conditions.

10. The method of claim 9, wherein determining further includes assigning any items associated with a single quantity condition as a single item combination in the item combinations.

11. The method of claim 7, wherein determining further includes determining a total number of item combinations as M factorial where M is an Integer that is less than N and N is a total number of the items.

12. The method of claim 7, wherein calculating further includes calculating particular discount values for the item combinations that are permissible to overlap with one another.

13. The method of claim 8, wherein calculating further includes calculating additional discount values for the item combinations that include a single particular item.

14. The method of claim 13, wherein selecting further includes selecting the largest discount value from the discount values, the particular discount values, and the additional discount values.

15. The method of claim 7, wherein the hardware device is one of: a Self-Service Terminal, a Point-Of-Sale Terminal, and a server.

16. A terminal, comprising:
a processor; and
a selection engine configured to: i) execute on the processor and ii) resolve a largest discount value for a transaction having multiple items and multiple offer conditions based on single item combinations producing single item discount values for the transaction and multiple item combinations producing multiple item combination discount values.

17. The terminal of claim 16, wherein the selection engine is further configured, in ii), to resolve the largest discount value based on permissible overlapping item combinations and impermissible overlapping item combinations.

18. The terminal of claim 16, wherein the selection engine is integrated into a retail promotion engine as an enhancement to promotion processing for that retail promotion engine.

19. The terminal of claim 16, wherein the terminal is a server that resolves the largest discount value for a Point-Of-Sale (POS) terminal that is processing the transaction remove from the server over a network connection.

20. The terminal of claim 16, wherein the terminal is one of: a Self-Service Terminal, a Point-Of-Sale terminal, an Automated Teller Machine, a retail server, and a mobile device.
